(19) United States
(12) Patent Application Publication
(10) Pub. No.: US 2008/0169956 A1
(43) Pub. Date: Jul. 17, 2008

(54) Operating Device

(76) Inventors: Shinya Matsuyama, Tokyo (JP); Masaki Yagisawa, Saitama (JP)

Correspondence Address: CHAPMAN AND CUTLER, 111 WEST MONROE STREET, CHICAGO, IL, 60603, US

(21) Appl. No.: 11/663,662

(22) PCT Filed: Oct. 3, 2005
(86) PCT No.: PCT/JP05/18304

§ 371 Date: Nov. 5, 2007

(30) Foreign Application Priority Data
Oct. 5, 2004 (JP) 2004-293079

(51) Int. Cl. G08C 19/12; H04L 17/02; H01H 9/18; H01H 35/26; H01H 3/12; H04Q 9/00; H01H 9/16

(52) U.S. Cl. 341/176; 398/141

(57) ABSTRACT

An operating device enabling recognition, even in a dark room, that an operation of an operating unit has been detected, whether or not a desired main device is operated by the operating device. The device 1 is connected to a main device 20 via signal lines K and G, and outputs an operation signal corresponding to an operation of an operating unit 2, to the main device 20 via the signal lines, and has: an operation detecting section 5 for detecting operation of the operating unit 2; a tube unit 9 having translucency and covering the signal line G; a tube unit irradiating section 12 disposed to emit light from an end portion side of the tube unit 9; and a tube unit irradiation controlling section 14 for controlling irradiation of the irradiating section 12 as operation of the operating unit 2 is detected by the operation detecting section 5.

### TECHNICAL FIELD

The present invention relates to an operating device for performing, for example, dimming control of lighting equipment or performing volume control of acoustic equipment. More specifically, this invention relates to an operating device connected to a main device via a signal line.

### RELATED ART

As a conventional operating device for performing a predetermined operation of a main device, there is such device as a remote control transmitter capable of turning on and off, or performing dimming control of lighting equipment (See Patent Document 1).

In addition, there is such device as a volume operating terminal connected to a volume controlling terminal, which is a main device, via a signal line (See Patent Document 2).

### Patent Document 1:

### Japanese Patent Application Laid-Open No. 2002-75667 (Page 3, FIG. 1)

### Patent Document 2:

Japanese Patent Application Laid-Open No. H11-331980 (Page 3, FIG. 1)

### DISCLOSURE OF THE INVENTION

### Problems to be Solved by the Invention

In the remote control transmitter of lighting equipment in Patent Document 1, the lighting equipment, which is a main device, can be turned on or off, or dimmed by a power switch or a dimming switch of the remote control transmitter. However, it is sometimes difficult to recognize whether various switch operations have been performed without fail when, for example, the predetermined operation is performed in a dark room or the like.

In the volume operating terminal or the like as disclosed in Patent Document 2, in addition to the problems as described above, when, for example, another terminal, which can be operated by a predetermined operating device, than the volume controlling terminal that is the main device of the volume operating terminal, is provided in the same room as the volume controlling terminal, there is the problem that it is difficult to recognize which terminal (main device) is operated by the volume operating terminal.

In order to solve such problems, an object of the present invention is to provide an operating device positively enabling a user to visually recognize, even in a dark room or the like, that an operation of an operating unit has been detected, and whether or not a desired main device is operated by the operating device.

### Means for Solving the Problems

In order to solve the problems as described above, according to a first aspect of the present invention, an operating device that is connected to a main device via a signal line and outputs a predetermined operation signal corresponding to an operation of an operating unit, to the main device via the signal line, comprises:

an operation detecting section for detecting the operation of the operating unit;
a tube unit having translucency and covering the signal line;
a tube unit irradiating section disposed so as to be able to emit light from an end portion side of the tube unit; and
a tube unit irradiation controlling section for performing irradiation control of the tube unit irradiating section according as the operation of the operating unit has been detected by the operation detecting section.

In the above aspect, when the operation of the operating unit has been detected, light is emitted from the end portion side of the tube unit by the tube unit irradiating section. The tube unit thereby glows in the longitudinal direction, and it is possible to give an operator the impression that the predetermined operation signal is output though the signal line by the operation of the operating unit. Therefore, it is possible to make an operator effectively recognize, even in a dark room, that the operation of the operating unit has been detected, and whether or not a desired main device is operated by the operation of the operating unit, by the light presentation.

Here, the irradiation control of the tube unit irradiating section includes, for example, the control of changing an irradiation status such as light intensity, light color, lighting and blinking in response to an operation, as well as the control of emitting light from the tube unit irradiating section according as the operation has been detected.

According to a second aspect of the present invention, the operating device according to the first aspect is characterized in that the tube unit irradiation controlling section performs the irradiation control by gradually increasing irradiating light intensity of the tube unit irradiating section according as the operation of the operating unit has been detected by the operation detecting section.

In the above aspect, since the irradiation range of the irradiating light from the tube unit irradiating section gradually extends, it is possible to effectively show by the light presentation the state that the predetermined operation signal is output through the signal line toward the main device, and the presentation effect increases.

According to a third aspect of the present invention, the operating device according to the first or second aspect is characterized in that the operating unit comprises a balloon having flexibility, in which a gas or a liquid is sealed in its interior chamber, and the operation detecting section comprises a pressure detecting section for detecting a pressure in the interior chamber.

In the above aspect, when the balloon is pressurized, the operation of the operating unit is detected, and thus, it is possible to make an operator effectively realize that the operator is operating the operating unit.

According to a fourth aspect of the present invention, the operating device according to the third aspect, further comprises:

the balloon, at least one portion of which has translucency;
a balloon irradiating section disposed so as to be able to irradiate the balloon from within; and
a balloon irradiation controlling section for performing irradiation control of the balloon irradiating section according as the operation of the operating unit has been detected by the operation detecting section.

In the above aspect, the irradiation of the balloon, which constitutes the operating unit, as well as the irradiation of the tube unit is controlled according as the operation of the operating unit has been detected by the operation detecting section. Therefore, it is possible to make an operator effectively recognize that the operation of the operating unit has been detected.

Here, the irradiation control of the balloon irradiating section includes, for example, the control of changing an irradiation status such as light intensity, light color, lighting and blinking in response to an operation, as well as the control of emitting light from the balloon irradiating section according as the operation has been detected.

According to a fifth aspect of the present invention, the operating device according to any one of the first to fourth aspects is characterized in that the balloon has a cylindrical shape, and the tube unit irradiation controlling section is disposed in a column-shaped space formed in the center of the cylindrical balloon.

In the above aspect, since the entire balloon surface works as the operating unit, its operability is improved. At the same time, the irradiation controlling section can be effectively accommodated in the operating unit, and thus, the operating device can be downsized.

According to a sixth aspect of the present invention, the operating device according to any one of the first to fifth aspects is characterized in that at least the signal line covered by the tube unit comprises an optical fiber.

In the above aspect, the irradiating light from the tube unit irradiating section is reflected diffusely by an inner surface of the tube unit and an outer surface of the optical fiber, and thus, it is possible to effectively extend the irradiation range of the irradiating light from the tube unit irradiating section, to thereby increase the effect of presentation.

### BRIEF DESCRIPTION OF THE DRAWINGS

FIG. 1 is a perspective view illustrating the entire image of an operating device as an embodiment of the present invention;

FIG. 2 is a cross-section view of the operating device along A-A in FIG. 1;

FIG. 3 is a block diagram illustrating the configuration of the operating device in FIG. 1; and.

FIGS. 4A to 4C are schematic views illustrating actions of the operating device in FIG. 1 and a main device.

### EXPLANATIONS OF REFERENCE NUMERALS

1: Operating Device

2: Balloon (Operating Unit)

3: Protective Tube

5: Pressure Sensor (Operation Detecting Section)

6: Communicating Tube

9: Tube unit

12: Tube Unit Irradiating LED (Tube Unit Irradiating Section)

13: Control Substrate

14: Controlling Section
(Tube Unit Irradiation Controlling Section,
Balloon Irradiation Controlling Section)

16: Balloon Irradiating LED (Balloon Irradiating Section)

20: Lighting Equipment (Main Device)

R: Air Chamber (Interior Chamber)

S: Accommodating Portion

### BEST MODES FOR CARRYING OUT THE INVENTION

An embodiment of the present invention is described below.

### Embodiment

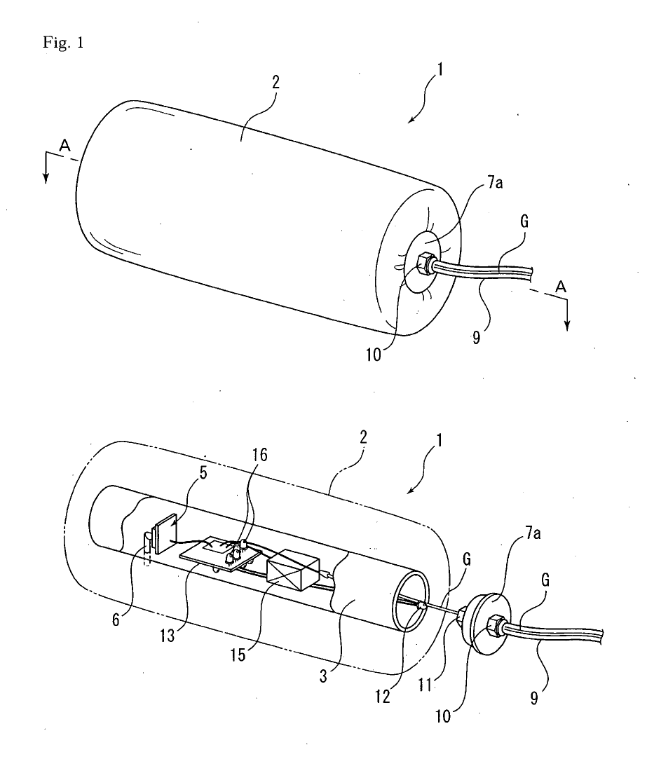

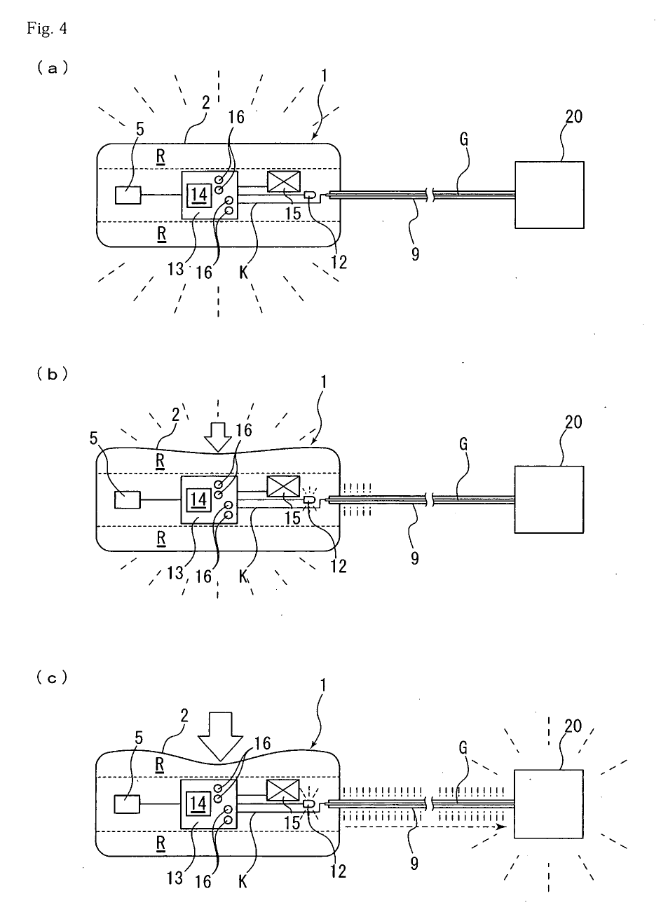

To describe the embodiment of the present invention based on the drawings, FIG. 1 illustrates the enter image of an operating device 1 as the embodiment of the present invention. The operating device 1 is adapted to turn on or off a lighting equipment 20 which is a main device (See FIG. 4).

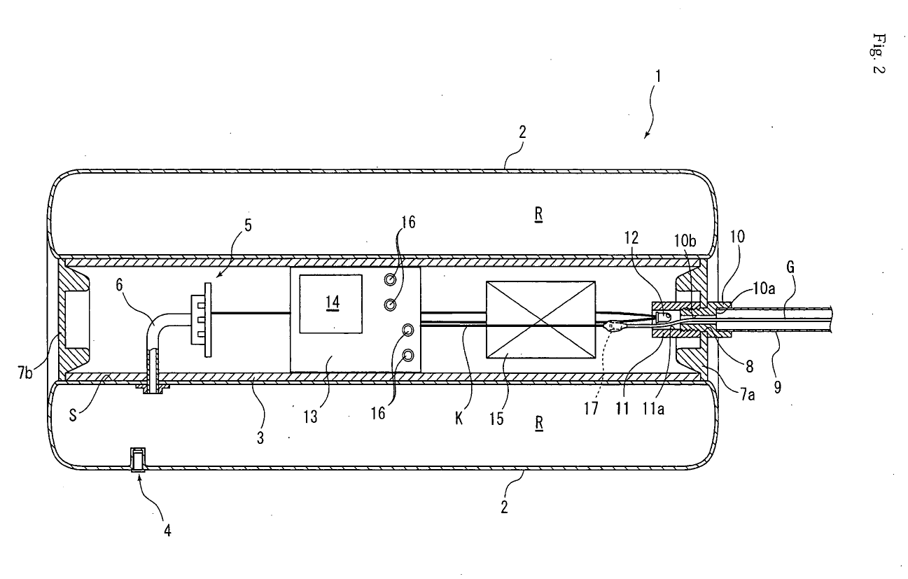

An outer shape of the operating device 1 of the present embodiment comprises a balloon 2 having flexibility, which is formed as a bag body, in which a gas (air) can be sealed, by a translucent polyurethane resin material. As shown in FIG. 2, the balloon 2 has a cylindrical shape so that a column-shaped space S is formed in its center, and a protective tube 3 made of a transparent acryl resin material is inserted and fit together in the space S with various sections as described below provided therein.

An injecting section 4 for injecting a gas into an air chamber R is formed in a predetermined place of an outer surface of the balloon 2. Although air (gas) is injected into the air chamber R in the present embodiment, a liquid may be injected. Also, provided in a predetermined place of an inner surface of the balloon 2 of the space S side is a communicating tube 6, which extends through from a detecting section of a pressure sensor 5 as a pressure detecting section for detecting an air pressure in the air chamber R, and the detecting section of the pressure sensor 5 is communicated with the air chamber R via the communicating tube 6 so that the air pressure in the air chamber R can be detected by a gas flowing out from the air chamber R via the communicating tube 6.

Both end surfaces in the longitudinal direction of the protective tube 3 are sealed by covers 7a and 7b, and a through hole 8 for inserting an optical fiber G as a signal line connected to a main device as described below is formed in the center of the cover 7a in the right side of FIG. 2. A connecting bolt 10 for connecting an end portion of a tube unit 9, which covers the optical fiber G, with the cover 7a is inserted and fit into the through hole 8 from an outside, and is maintained in the cover 7a by a metal nut 11 screwed into a periphery of a projecting portion in the interior side of the cover 7a.

A translucent polyurethane resin material having translucency is used to form the tube unit 9, and the optical fiber G is inserted into the tube unit 9 without being fixed. An internal diameter of the tube unit 9 in the present embodiment is set to about 5 mm which is larger than an external diameter of the optical fiber G, and there is a space between an inner surface of the tube unit 9 and an outer surface of the optical fiber G.

The connecting bolt 10 is made of metal, a connecting concave portion 10a, to which the end portion of the tube unit 9 is connected, is formed on its head, and a through hole lob is formed in the center of the bolt in the axial direction, into which the optical fiber C is inserted.

The nut 11 has a predetermined length, and a tube unit irradiating LED 12 as a tube unit irradiating section for irradiating an interior portion of the tube unit 9 is disposed in the end portion opposite the side from which the connecting bolt 10 is screwed into a center screw hole 11a, so as to be able to emit light (blue irradiating light in the present embodiment) from the end portion side of the tube unit 9.

Disposed in the protective tube 3 is: a control substrate 13 on which a controlling section 14, comprising MPU or the like which constitutes a tube unit irradiation controlling section and a balloon irradiation controlling section for performing irradiation control of the tube unit irradiating LED 12 and a balloon irradiating LED 16, as a balloon irradiating section as described below, based on a pressure detected by the pressure sensor 5 as described below, is provided; and a battery 15 for supplying power to each section of the controlling section 14 or the like mounted on the control substrate 13. The control substrate 13 is disposed approximately in the center of the protective tube 3 in the longitudinal direction, and a plurality of balloon irradiating LEDs 16 are disposed on its top and bottom surfaces for irradiating the entire balloon 2 from within (blue irradiating light in the present embodiment).

In addition, a signal line K for outputting a predetermined operation signal to a main device extends from the control substrate 13. An end portion of the signal line K is connected to the optical fiber G via an IR (Infrared)LED 17 in the protective tube 3, and the predetermined operation signal (electronic signal) is converted into an optical signal, which is output to the lighting equipment 20 that is the main device.

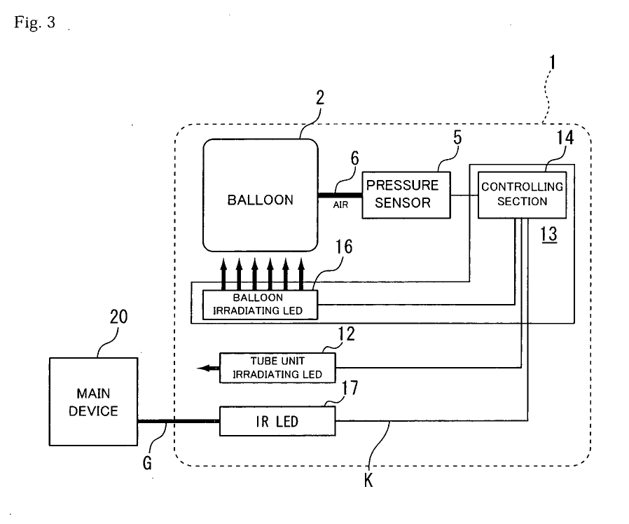

Next, to describe the configuration of the operating device 1 and the lighting equipment 20 of the present embodiment based on the block diagram of FIG. 3, the operating device 1 and the lighting equipment 20 comprise the balloon 2 constituting an operating unit of the operating device 1, the pressure sensor 5 for detecting the air pressure in the air chamber R of the balloon 2, the tube unit irradiating LED 12 for irradiating the interior portion of the tube unit 9, the balloon irradiating LED 16 for irradiating the entire balloon 2 from within, the IRLED 17 for performing infrared communication, and the control substrate 13 by which the pressure sensor 5, the tube unit irradiating LED 12, the balloon irradiating LED 16, and the IRLED 17 are connected and on which the controlling section 14 for controlling the above sections is provided.

Next, an action of the operating device 1 as the present embodiment is described based on FIG. 4.

First, when the balloon 2 constituting the operating device 1 is pressurized and the air pressure in the air chamber R increases to a predetermined upper limit, a turn-on signal (predetermined operation signal) for turning on the lighting equipment 20 is output to the lighting equipment 20 via the signal line K and the optical fiber G, and the lighting equipment 20 is turned on. Also, when the air pressure in the air chamber R decreases to a predetermined lower limit, a turn-off signal (predetermined operation signal) for turning off the lighting equipment 20 is output via the signal line K and the optical fiber C, and the lighting equipment 20 is turned off.

In normal times when the balloon 2 is not pressurized, the tube unit irradiating LED 12 is kept turned off, the balloon irradiating LED 16 is kept turned on, and the entire transparent balloon 2 is irradiated from within. When the balloon 2 is pressurized and the air pressure in the air chamber R increases, the tube unit irradiating LED 12 gradually lights up corresponding to the pressure increase. Accordingly, the irradiation range of the irradiating light from the tube unit irradiating LED 12 gradually extends from the end portion side of the operating device 1 toward the lighting equipment 20 side of the tube unit 9.

As described above, the light intensity of the tube unit irradiating LED 12 gradually increases corresponding to the pressure increase. Accordingly, when the turn-on operation of the lighting equipment 20 is performed by pressing the balloon 2 which is the operating unit, it is possible to effectively show by the light presentation the state that the turn-on signal is output via the optical fiber G corresponding to the above turn-on operation. Therefore, it is possible to effectively make an operator recognize that the pressing operation of the balloon 2 which is the operating unit has been detected.

Next, the irradiation control procedure which the controlling section 14 performs corresponding to the state of the balloon 2 is described based on FIG. 4. The controlling section 14 constantly monitors the detection status of the pressure by the pressure sensor 5. When the controlling section 14 determines that the balloon 2 is not pressurized as shown in FIG. 4A, in other words, that the pressure is lower than the predetermined lower limit, the controlling section 14 keeps the tube unit irradiating LED 12 turned off and the balloon irradiating LED 16 turned on at a predetermined level of light intensity. In this state, the entire balloon 2, which is transparent, is irradiated from its inside, and it is possible to easily find the operating device 1 even in a dark room.

Next, as shown in FIG. 4B, when a user place his or her head or the like on a top of the balloon, the balloon 2 is pressurized and become deformed, and when it is determined that the air pressure is over the predetermined lower limit by the increase in the air pressure in the air chamber R, the tube unit irradiating LED 12 is turned on.

In other words, the controlling section 14 performs the controls of changing the light intensity of the tube unit irradiating LED 12 and the balloon irradiating LED (dimming control) corresponding to the pressure detected by the pressure sensor 5. More specifically, in the present embodiment, the controlling section 14 performs the control of gradually increasing the light intensity of the tube unit irradiating LED 12 and at the same time, gradually decreasing the light intensity of the balloon irradiating LED 16 corresponding to the increase in the air pressure in the air chamber R. By contrast, the controlling section 14 performs the control of gradually decreasing the light intensity of the tube unit irradiating LED 12 and at the same time, gradually increasing the light intensity of the balloon irradiating LED 16 corresponding to a decrease in the air pressure in the air chamber R.

Furthermore, when the balloon 2 is more pressurized and become more deformed as shown in FIG. 4C than in FIG. 4B and it is determined that the air pressure reaches the predetermined upper limit by the increase in the air pressure in the air chamber R, the turn-on signal for turning on the lighting equipment 20 is output toward the lighting equipment 20. The output turn-on signal is transmitted through the signal line K and the optical fiber G to the lighting equipment 20, and the lighting equipment 20 is turned on by receiving the turn-on signal.

In addition, when the balloon 2 returns to the state shown in FIG. 4A and it is determined that the air pressure in the air chamber R is lower than the predetermined lower limit, the turn-off signal for turning off the lighting equipment 20 is output toward the lighting equipment 20. When the lighting equipment 20 receives the turn-off signal, the light is turned off.

As described above, in the operating device 1 as the embodiment of the present invention, when the pressing operation of the balloon 2 which is the operating unit has been detected, in other words, when the air pressure in the air chamber R has been detected to reach the predetermined upper limit, light is emitted from the end portion side of the tube unit 9 by the tube unit irradiating LED 12. The tube unit thereby glows in the longitudinal direction, and the predetermined operation signal (turn-on signal) seems to be output through the signal line K and the optical fiber G by the pressing operation of the balloon 2. Therefore, because of the light presentation, it is possible to make an operator effectively recognize, even in a dark room, that the operation of the balloon 2 has been detected, and whether or not a desired lighting equipment 20 is operated by the operation.

In addition, because the optical fiber G as the signal line is covered by the tube unit 9 and is thereby protected, it is possible to effectively prevent the line from being broken by damage or the like. Also, since the tube unit 9 glows by the irradiating light corresponding to the operation, it is possible to visually recognize wiring of the signal line of the operating device 1 even in a dark room, and therefore, there is no danger that, for example, a user catches his or her leg in the optical fiber G as the signal line to disconnect the optical fiber G. Furthermore, for example, even when there are provided a plurality of lighting equipments 20 as the main device which can be operated by a predetermined operating device, it is visually clear which main device is operated by the operating device 1 by tracing the light.

In addition, when the air pressure is over the predetermined lower limit, the tube unit irradiating LED 12 is turned on. The light intensity of the tube unit irradiating LED 12 gradually increases corresponding to the pressure increase, and the irradiation range of the irradiating light from the tube unit irradiating LED 12 thereby extends gradually. Therefore, it is possible to more effectively show the state that the predetermined operation signal is output through the signal line K and the optical fiber G to the lighting equipment 20.

By using the optical fiber G as the signal line which is inserted (without being fixed) into the tube unit 9, the irradiating light from the tube unit irradiating LED 12 is reflected diffusely by the inner surface of the tube unit 9 and the outer surface of the optical fiber G, and thus, it is possible to effectively extend the irradiation range of the irradiating light from the tube unit irradiating LED 12, to thereby increase the effect of presentation.

In addition, by performing irradiation control of the balloon irradiating LED 16 at the same time as the tube unit irradiating LED 12 corresponding to the pressure change, changes in the light can be clearly recognized. Therefore, it is possible to effectively make an operator recognize that the operation of the operating unit has been detected.

In addition, since the operating unit of the operating device 1 in the present embodiment is composed of the balloon 2, it is possible to make an operator effectively realize that the operator is operating the operating unit. Also, since the balloon 2 has a cylindrical shape, the entire balloon surface works as the operating unit, and its operability is improved. At the same time, the control substrate 13 and various sections can be effectively accommodated in the balloon 2 which is the operating unit, and thus, the entire operating device 1 can be downsized.

Although the embodiment of the present invention is described based on the drawings as described above, specific configuration is not limited to the embodiment, and modification or addition may be made in the present invention within the range not departing from the scope of the invention.

For example, although the lighting equipment 20 is used as the main device in the above embodiment, the present invention is not limited thereto. Other devices than the lighting equipment, such as acoustic equipment and air-conditioning equipment, may be applied as the main device, and an operating device capable of performing volume control of the acoustic equipment or indoor temperature control of the air-conditioning equipment may be applied as the operating device.

Although the operating device 1 in the above embodiment is configured to output the turn-on signal or the turn-off signal corresponding to the air pressure in the air chamber R to turn on or off the lighting equipment 20, the operating device 1 may be configured to be able to output operation signals for changing the light intensity of the lighting equipment 20 in a phased manner corresponding to the types of operations of the operating unit, to enable the operation (dimming control) of changing the light intensity of the lighting equipment 20 in a phased manner by outputting the operation signals. That is, the tube unit irradiation controlling section and the balloon irradiation controlling section may be adapted to perform control of emitting light from the tube unit irradiating section and the balloon irradiating section by the irradiation status corresponding to the types of detected operations.

Although, in the above embodiment, the controlling section 14 of the operating device 1 performs dimming control by changing the light intensity of the tube unit irradiating LED 12 or the balloon irradiating LED 16 corresponding to the change in the air pressure in the air chamber R, the present invention is not limited thereto. The irradiation status, such as the light color, lighting and blinking of the tube unit irradiating LED 12 or the balloon irradiating LED 16 may be changed corresponding to the air pressure in the air chamber R. For example, the tube unit irradiating LED 12 or the balloon irradiating LED 16 may be a color LED capable of emitting a plurality of colors of light, to emit different colors of irradiating light corresponding to the types of the operation signal, or to change the color of the irradiating light corresponding to the change in the air pressure.

In addition, in the above embodiment, when the air pressure in the air chamber R becomes over the predetermined lower limit, the controlling section 14 of the operating device 1 starts irradiation control of the tube unit irradiating LED 12 and the balloon irradiating LED 16 in a state in which the turn-on signal as the operation signal has not been output. However, the irradiation control of the tube unit irradiating LED 12 and the balloon irradiating LED 16 may be performed in response only to the output of the predetermined operation signal.

Although, in the above embodiment, the balloon 2 has a cylindrical shape, the shape of the balloon 2 is not limited to the cylindrical shape. The balloon 2 may be of various shapes such as column-shape, spherical shape or the like, and also, the shape may not be used in which the entire surface works as the operating unit as the balloon 2 in the present embodiment.

In the present embodiment, the pressure sensor 5, which detects the air pressure in the air chamber R in the balloon 2 as the operating unit, is applied as the operation detecting section for detecting the operation of the operating unit in the operating device 1. However, the present invention is not limited to the configuration that the operating unit is composed of the balloon and the operation thereof is detected by the pressure. For example, the operating device 1 may be composed of a case unit having no flexibility, the operating unit may be composed of a normal switch or the like, and the operation of the switch may be detected by, for example, a photo switch.

Although LED is used for the tube unit irradiating LED 12 as the tube unit irradiating section and the balloon irradiating LED 16 as the balloon irradiating section, the tube unit irradiating section and the balloon irradiating section may be composed of a lamp or the like.

1. An operating device for controlling operation of a main device, comprising:
an operation detecting section for detecting operation of an operating unit;
a tube unit having translucency and covering a signal line that connects the operating device with the main device, through which the operating device outputs to the main device a predetermined operation signal corresponding to an operation of the operating unit;
a tube unit irradiating section disposed so as to emit light from an end portion side of the tube unit; and
a tube unit irradiation controlling section for performing irradiation control of the tube unit irradiating section corresponding to the operation of the operating unit detected by the operation detecting section.

2. The operating device according to claim 1, wherein the tube unit irradiation controlling section performs the irradiation control by gradually increasing irradiating light intensity of the tube unit irradiating section according to the operation of the operating unit detected by the operation detecting section.

3. The operating device according to claim 1, wherein the operating unit comprises a balloon having flexibility and comprising an interior chamber, in which a gas or a liquid is sealed, and
the operation detecting section comprises a pressure detecting section for detecting a pressure in the interior chamber.

4. The operating device according to claim 3, wherein at least one portion of the balloon has translucency, and further comprising:
a balloon irradiating section disposed so as to irradiate the balloon from within; and
a balloon irradiation controlling section for performing irradiation control of the balloon irradiating section corresponding to the operation of the operating unit detected by the operation detecting section.

5. The operating device according to claim 3, wherein the balloon has a cylindrical shape, and the tube unit irradiation controlling section is disposed in a column-shaped space formed in a center of the cylindrical balloon.

6. The operating device according to claim 1, wherein the signal line covered by the tube unit comprises an optical fiber.

7. The operating device according to claim 2, wherein the operating unit comprises a balloon having flexibility and comprising an interior chamber, in which a gas or a liquid is sealed, and
the operation detecting section comprises a pressure detecting section for detecting a pressure in the interior chamber.

8. The operating device according to claim 4, wherein the balloon has a cylindrical shape, and the tube unit irradiation controlling section is disposed in a column-shaped space formed in a center of the cylindrical balloon.

9. The operating device according to claim 7, wherein the balloon has a cylindrical shape, and the tube unit irradiation controlling section is disposed in a column-shaped space formed in a center of the cylindrical balloon.

10. The operating device according to claim 2, wherein the signal line covered by the tube unit comprises an optical fiber.

11. The operating device according to claim 3, wherein the signal line covered by the tube unit comprises an optical fiber.

12. The operating device according to claim 4, wherein the signal line covered by the tube unit comprises an optical fiber.

13. The operating device according to claim 5, wherein the signal line covered by the tube unit comprises an optical fiber.

14. The operating device according to claim 7, wherein the signal line covered by the tube unit comprises an optical fiber.

15. The operating device according to claim 8, wherein the signal line covered by the tube unit comprises an optical fiber.

16. The operating device according to claim 9, wherein the signal line covered by the tube unit comprises an optical fiber.
